(19) United States
(12) Patent Application Publication
(10) Pub. No.: US 2023/0307760 A1
(43) Pub. Date: Sep. 28, 2023

(54) SELECTABLE SHIM SYSTEMS FOR TRACTION BATTERY PACKS WITH CELL-TO-PACK BATTERY SYSTEMS

(71) Applicant: FORD GLOBAL TECHNOLOGIES, LLC, Dearborn, MI (US)

(72) Inventors: Patrick Daniel MAGUIRE, Ann Arbor, MI (US); Marc DUGAS, Wixom, MI (US)

(21) Appl. No.: 17/894,235

(22) Filed: Aug. 24, 2022

Related U.S. Application Data
(60) Provisional application No. 63/322,766, filed on Mar. 23, 2022.

(51) Int. Cl. H01M 50/233; B60L 50/64; B60L 50/60; H01M 50/204; H01M 10/04; H01M 50/289

(52) U.S. Cl. CPC H01M 50/233; B60L 50/64; B60L 50/66; H01M 50/204; H01M 10/0481; H01M 50/289; H01M 2220/20

(57) ABSTRACT

A traction battery pack includes a cell-to-pack battery system. A selectable shim system may be used to augment a compressive load applied to one or more cell stacks of the cell-to-pack battery system. A method of assembling the traction battery pack may include measuring a first dimension associated with each cell stack of the cell-to-pack battery system, measuring a second dimension associated with an enclosure tray, and selecting an appropriately sized shim of the selectable shim system for applying a desired amount of compression to the battery cells of each cell stack when the cell stack is received within the enclosure tray.

### CROSS-REFERENCE TO RELATED APPLICATIONS

This disclosure claims priority to U.S. Provisional Application No. 63/322,766, which was filed on Mar. 23, 2022 and is incorporated herein by reference.

### TECHNICAL FIELD

This disclosure relates generally to traction battery packs that include cell-to-pack battery systems, and more particularly to selectable shim systems for applying a desired amount of compression to cell stacks of the cell-to-pack battery system.

### BACKGROUND

Electrified vehicles include a drivetrain having one or more electric machines. The electric machines can drive the electrified vehicles instead of, or in addition to, an internal combustion engine. A traction battery pack can power the electric machines and other electrical loads of the vehicle.

Conventional traction battery packs include groupings of battery cells called battery arrays. The battery arrays include various array support structures (e.g., array frames, spacers, rails, walls, end plates, bindings, etc.) that are arranged for grouping and supporting the battery cells in multiple individual units inside the traction battery pack enclosure.

### SUMMARY

A traction battery pack according to an exemplary aspect of the present disclosure includes, among other things, an enclosure assembly including an enclosure tray, a cell-to-pack battery system housed within the enclosure assembly and including a first cell stack, and a first shim positioned between a first side wall of the enclosure tray and the first cell stack.

In a further non-limiting embodiment of the foregoing traction battery pack, the first cell stack establishes a cell row of a cell matrix of the cell-to-pack battery system.

In a further non-limiting embodiment of either of the foregoing traction battery packs, the enclosure tray provides a cell-compressing opening for compressing the cell matrix.

In a further non-limiting embodiment of any of the foregoing traction battery packs, the first shim is part of a selectable shim system that further includes a second shim positioned between the first side wall and a second cell stack of the cell-to-pack battery system.

In a further non-limiting embodiment of any of the foregoing traction battery packs, the first shim includes a first thickness that is different from a second thickness of the second shim.

In a further non-limiting embodiment of any of the foregoing traction battery packs, the first shim includes a first thickness that is the same as a second thickness of the second shim.

In a further non-limiting embodiment of any of the foregoing traction battery packs, the selectable shim system further includes a third shim positioned between the first side wall and a third cell stack of the cell-to-pack battery system.

In a further non-limiting embodiment of any of the foregoing traction battery packs, the third shim includes a third thickness that is different from the first thickness and the second thickness.

In a further non-limiting embodiment of any of the foregoing traction battery packs, the selectable shim system further includes a fourth shim positioned between the first side wall and a fourth cell stack of the cell-to-pack battery system.

In a further non-limiting embodiment of any of the foregoing traction battery packs, the fourth shim includes a fourth thickness that is different from the first thickness, the second thickness, and the third thickness.

In a further non-limiting embodiment of any of the foregoing traction battery packs, the fourth shim includes a fourth thickness that is the same as the first thickness, the second thickness, or the third thickness.

In a further non-limiting embodiment of any of the foregoing traction battery packs, the first shim includes a plate-like body and includes a non-flammable, moldable polymer that includes insulating properties.

In a further non-limiting embodiment of any of the foregoing traction battery packs, the first shim is arranged to apply a preload to a plurality of battery cells of the first cell stack.

In a further non-limiting embodiment of any of the foregoing traction battery packs, the cell-to-pack battery system includes a second cell stack, and no shim is positioned between the first side wall and the second cell stack.

A method according to another exemplary aspect of the present disclosure includes, among other things, measuring a first dimension associated with a cell stack of a cell-to-pack battery system for a traction battery pack, measuring a second dimension associated with an enclosure tray of the traction battery pack, and selecting a shim based on the first dimension and the second dimension.

In a further non-limiting embodiment of the foregoing method, measuring the first dimension includes measuring an end-to-end length of the cell stack.

In a further non-limiting embodiment of either of the foregoing methods, measuring the second dimension includes measuring a distance between a first side wall and an opposing second side wall of the enclosure tray at a location where the cell stack is to be inserted into the enclosure tray.

In a further non-limiting embodiment of any of the foregoing methods, selecting the shim includes selecting the shim based on a difference between the second dimension and the first dimension.

In a further non-limiting embodiment of any of the foregoing methods, the method includes repeating the measuring and the selecting steps for each additional cell stack of the cell-to-pack battery system.

In a further non-limiting embodiment of any of the foregoing methods, the method includes inserting the cell stack together with the additional cell stacks into a cell-compressing opening of the enclosure tray.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell-to-pack battery system of the traction battery pack of FIG. 2.

FIG. 4 illustrates another cell-to-pack battery system for a traction battery pack.

FIG. 5 illustrates a selectable shim system for a traction battery pack having a cell-to-pack battery system.

FIG. 6 illustrates another selectable shim system.

FIG. 7 illustrates another selectable shim system.

FIG. 8 illustrates yet another selectable shim system.

FIG. 9 schematically illustrates a method of assembling a traction battery pack.

FIG. 10 illustrates a first dimension associated with a cell stack of a cell-to-pack battery system.

FIG. 11 illustrates a second dimension associated with an enclosure tray of a traction battery pack that includes a cell-to-pack battery system.

### DETAILED DESCRIPTION

This disclosure details traction battery packs that include cell-to-pack battery systems. A selectable shim system may be used to augment a compressive load applied to one or more cell stacks of the cell-to-pack battery system. A method of assembling the traction battery pack may include measuring a first dimension associated with each cell stack of the cell-to-pack battery system, measuring a second dimension associated with an enclosure tray, and selecting an appropriately sized shim of the selectable shim system for applying a desired amount of compression to the battery cells of each cell stack when the cell stack is received within the enclosure tray. These and other features are discussed in greater detail in the following paragraphs of this detailed description.

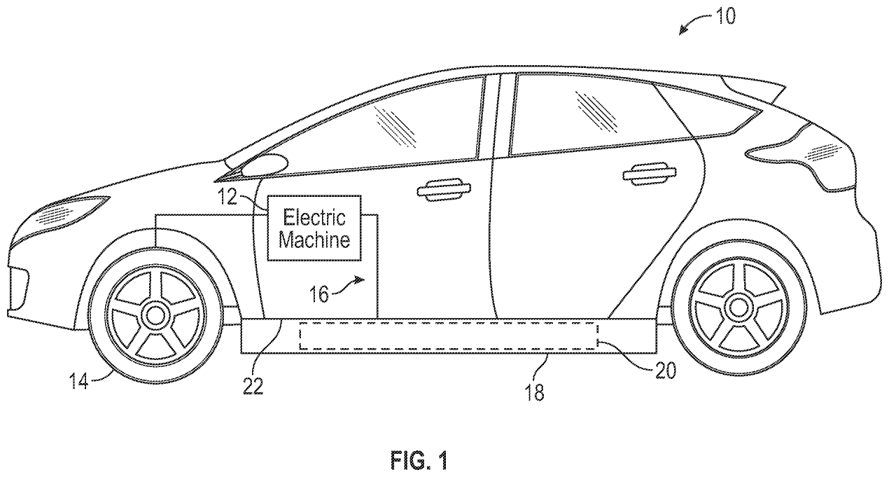

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In an embodiment, the electrified vehicle 10 is a car. However, the electrified vehicle 10 could alternatively be a pickup truck, a van, a sport utility vehicle (SUV), or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more drive wheels 14 of the electrified vehicle 10.

A voltage bus 16 may electrically couple the electric machine 12 to a traction battery pack 18. The traction battery pack 18 is capable of outputting electrical power to power the electric machine 12 and/or other electrical loads of the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

The traction battery pack 18 is an exemplary electrified vehicle battery. The traction battery pack 18 may be a high voltage traction battery pack that includes a cell-to-pack battery system 20. Unlike conventional traction battery pack battery systems, the cell-to-pack battery system 20 incorporates battery cells or other energy storage devices without the cells being arranged in individual arrays or modules. The cell-to-pack battery system 20 therefore eliminates most if not all the array support structures (e.g., array frames, spacers, rails, walls, end plates, bindings, etc.) necessary for grouping the battery cells into the arrays/modules. Further, the cell-to-pack battery system 20 may provide the total high voltage bus electrical potential of the traction battery pack 18 with a single battery unit as opposed to conventional battery systems that require multiple individual battery arrays/modules that must be connected together after being positioned within the battery enclosure for achieving the total high voltage electrical potential.

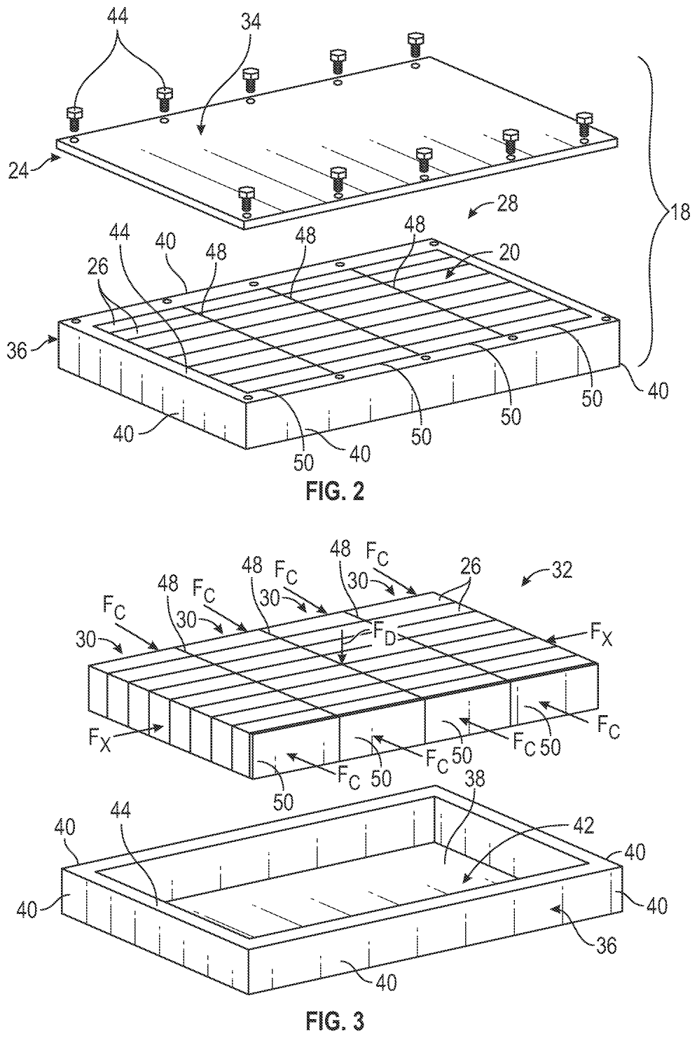

Referring now to FIGS. 2 and 3, the traction battery pack 18 may include an enclosure assembly 24 that is arranged for housing the cell-to-pack battery system 20. In an embodiment, the cell-to-pack battery system 20 includes a plurality of battery cells 26 that are held within an interior area 28 established by the enclosure assembly 24.

The battery cells 26 may supply electrical power to various components of the electrified vehicle 10. The battery cells 26 may be stacked side-by-side relative to one another to construct a cell stack 30, and the cell stacks 30 may be positioned side-by-side in rows to provide a cell matrix 32.

In an embodiment, each cell stack 30 includes eight individual battery cells 26, and the cell matrix 32 includes four cell stacks 30 for a total of thirty-two battery cells 26. Providing an even quantity of battery cells 26 and an even quantity of cell stacks 30 can help to support an efficient electrical bussing arrangement. Although a specific number of battery cells 26 and cells stacks 30 are illustrated in the various figures of this disclosure, the cell-to-pack battery system 20 of the traction battery pack 18 could include any number of battery cells 26 and any number of cell stacks 30. In other words, this disclosure is not limited to the exemplary configuration shown in FIGS. 2 and 3.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure assembly 24 of the traction battery pack 18 may include an enclosure cover 34 and an enclosure tray 36. The enclosure cover 34 may be secured to the enclosure tray 36 to provide the interior area 28 for housing the cell-to-pack battery system 20.

The enclosure tray 36 may include a floor 38 and a plurality of side walls 40 arranged relative to one another to provide a cell-compressing opening 42. The floor 38 and the side walls 40 may be mechanically coupled to one another, such as by welding, for example.

During assembly of the traction battery pack 18, the enclosure cover 34 may be secured to the enclosure tray 36 at an interface 44 that substantially circumscribes the interior area 28. In some implementations, mechanical fasteners 46 may be used to secure the enclosure cover 34 to the enclosure tray 36, although other fastening methodologies (adhesion, etc.) could also be suitable.

The cell matrix 32 of the cell-to-pack battery system 20 may be positioned within the cell-compressing opening 42 provided by the enclosure tray 36. The exemplary enclosure tray 36 is depicted as including a single cell-compressing opening 42, however it should be understood that this disclosure extends to structural assemblies that provide one or more cell-compressing openings. The enclosure cover 34 may cover the cell matrix 32 within the cell-compressing opening 42 to substantially surround the battery cells 26 on all sides. Once fully assembled and positioned relative to the enclosure tray 36, the cell matrix 32 may establish a single battery unit capable of providing the total high voltage bus electrical potential of the traction battery pack 18.

The enclosure tray 36 may compress and hold the cell matrix 32 when the cell matrix 32 is received within the cell-compressing opening 42. In an embodiment, the side walls 40 of the enclosure tray 36 apply forces to the cell matrix 32 when the cell matrix 32 is positioned within the cell-compressing opening 42.

In an embodiment, in order to insert the cell matrix 32 into the cell-compressing opening 42, the cell matrix 32 may first be compressed, and then, while compressed, moved into place in the cell-compressing opening 42. A compressive force Fc may be applied to opposed ends of one of the cell stacks 30. The compressive force Fc essentially squeezes the battery cells 26 within the cell stack 30, thereby compressing the cell stack 30 and the individual battery cells 26 to a reduced thickness. While the compressive force Fc is applied to the cell stack 30, the cell stack 30 may be inserted into a respective cell-compressing opening 42 by a downward force FD. The downward force FD may be applied directly to one or more of the battery cells 26.

While the term “downward” is used herein to describe the downward force FD, it should be understood that the term “downward” is used herein to refer to all forces tending to press a cell stack 30 into a cell-compressing opening 42. In particular, the term “downward” refers to all forces substantially perpendicular to the compressive forces Fc, whether or not the force is truly in a “downward” direction. For example, this disclosure extends to cell stacks that are compressed and inserted into a cell-compressing opening in a sideways direction.

The cell stacks 30 could be individually compressed and inserted into the cell-compressing opening 42. In another embodiment, the entire cell matrix 32 is compressed and inserted into the cell-compressing opening 42. As schematically shown in FIG. 3, in such an embodiment, additional compressive forces Fx can compress the cell stacks 30 together for insertion of the cell matrix 32 into the cell-compressing opening 42. The compressive forces Fx are generally perpendicular to the compressive forces Fc. The compressive forces Fx may be applied together with the compressive forces Fc. The force FD may then be applied to move the entire cell matrix 32 into the cell-compressing opening 42.

In an embodiment, an entire perimeter of the cell-compressing opening 42 is defined by the side walls 40 of the enclosure tray 36. The side walls 40 can apply a compressive force to the battery cells 26 about the entire perimeter of the cell matrix 32. The side walls 40 may therefore function as a rigid halo-type structure that compresses and tightly holds the cell matrix 32.

The configuration described above is considered to be a cell-to-pack type battery pack, which differs from conventional battery pack types that include enclosures holding arrays of battery cells enclosed by array support structures that are spaced apart from walls of a battery enclosure, and where the battery enclosure does not apply compressive forces to any of the battery cells. The cell-to-pack type battery pack described herein also eliminates the rigid cross members that are commonly secured to the enclosure tray of conventional traction battery backs for providing mounting points for securing the battery arrays and the enclosure cover.

The cell-to-pack battery system 20 may further include one or more cell row separators 48. In an embodiment, one cell row separator 48 is positioned between each adjacent pair of cell stacks 30 of the cell matrix 32. In other embodiments, two cell row separators 48 are provided with each cell stack 30. However, the total number of cell row separators 48 provided within the cell-to-pack battery system 20 is not intended to limit this disclosure.

It is typically desirable to maintain the battery cells 26 of each cell stack 30 in compression for achieving optimal functionality. However, applying the appropriate amount of compression to each cell stack 30 of the cell matrix 32 can be difficult due to tolerance variations that can occur along the side walls 40 of the enclosure tray 36 and/or tolerance variations that result from piece-to-piece dimensional variations among the battery cells 26 that can cause some cell rows to be different lengths than other cell rows. The traction battery pack 18 may therefore further include one or more shims 50 for filling in gaps caused by the tolerance variations. The shims 50 may further apply a preload to the battery cells 26 of each cell stack 30. The preload is the amount of force necessary to maintain the battery cells 26 in compression.

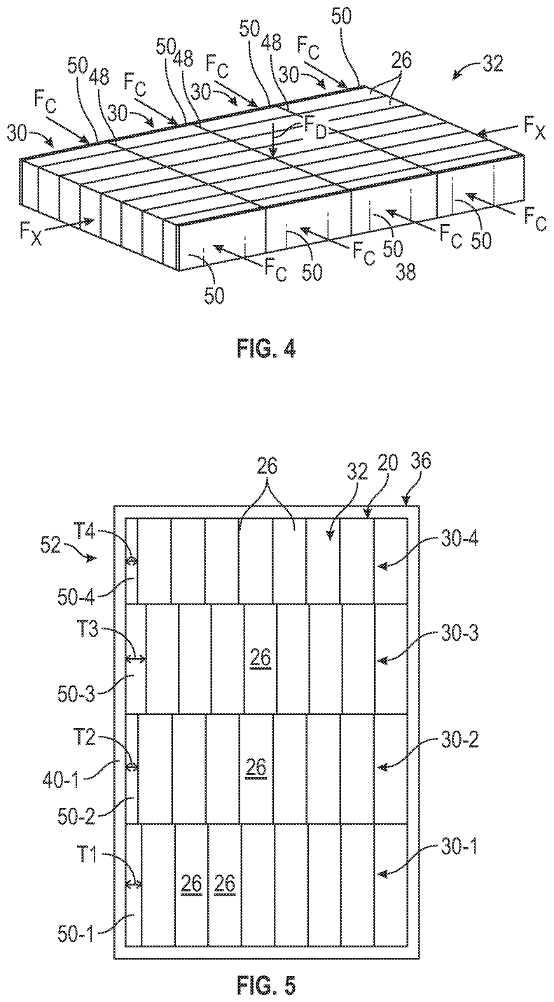

In an embodiment, one shim 50 may be positioned between each cell stack 30 and the enclosure tray 36, with the shim 50 being located at a longitudinal extent of the cell stack 30. In other implementations, two shims 50 may be provided for each cell stack 30, with one shim 50 being located at each longitudinal extent of the cell stack 30 (see FIG. 4). In still other implementations, some of the cell stacks 30 of the cell matrix 32 may not require a shim 50. Thus, the total number of shims 50 provided within the cell-to-pack battery system 20 could vary and is not intended to limit this disclosure.

The shims 50 may be positioned relative to the cell stacks 30 either before or after inserting the cell matrix 32 into the cell-compressing opening 42. Further, the shims 50 may be secured (e.g., via an adhesive) to the cell stacks 30, the enclosure tray 36, or both.

As further detailed below, the shims 50 may provide various functions and advantages to the cell-to-pack battery system 20, including but not limited to providing an appropriate preload for maintaining the battery cells 26 of the cell matrix 32 in compression, compensating for tolerance variations in the side walls 40 of the enclosure tray 36, insulating the cell matrix 32 from the exterior environment, providing a locating or receiving feature for the assembly tools to the cell stack or the cell stack to the battery structure, changing the friction between the cells and the enclosure, protecting the cell stack from direct contact and damage against the enclosure, absorbing energy, etc. The functionality provided by the shims 50 described herein may be particularly beneficial for traction battery packs that include cell-to-pack type battery systems because the array support structures traditionally provided as part of the battery arrays have been largely eliminated from the cell-to-pack battery system 20.

FIG. 5, with continued reference to FIGS. 1-4, illustrates a selectable shim system 52 for use within the traction battery pack 18 having the cell-to-pack battery system 20. The selectable shim system 52 may include a plurality of shims 50. As mentioned above, one or more shims 50 could be provided for each cell stack 30 of the cell-to-pack battery system 20.

In the illustrated embodiment, a first shim 50-1 is positioned between a first side wall 40-1 of the enclosure tray 36 and a first cell stack 30-1 of the cell-to-pack battery system 20, a second shim 50-2 is positioned between the first side wall 40-1 and a second cell stack 30-2 of the cell-to-pack battery system 20, a third shim 50-3 is positioned between the first side wall 40-1 and a third cell stack 30-3 of the cell-to-pack battery system 20, and a fourth shim 50-4 is positioned between the first side wall 40-1 and a fourth cell stack 30-4 of the cell-to-pack battery system 20. Although four shims 50 are shown as being part of the selectable shim system 52 of FIG. 5, a greater or fewer number of shims 50 could be provided depending on the number of cell stacks 30 that are part of the cell matrix 32.

The first shim 50-1 may include a first thickness T1, the second shim 50-2 may include a second thickness T2, the third shim 50-3 may include a third thickness T3, and the fourth shim 50-4 may include a fourth thickness T4. In an embodiment, each of the respective thicknesses T1, T2, T3, and T4 is a different thickness than the other respective thicknesses T1, T2, T3, or T4. Therefore, the selectable shim system 52 may include shims 50 of varying thicknesses.

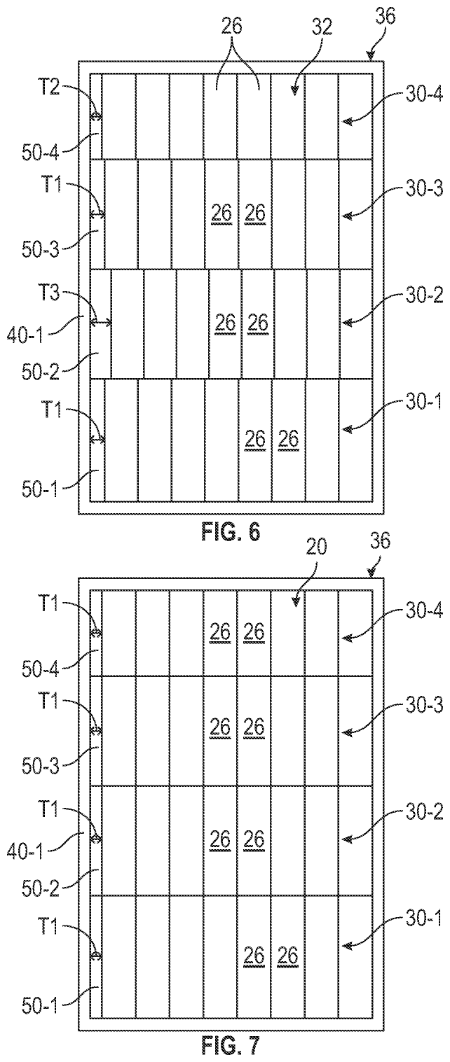

Other configurations of the selectable shim system 52 are additionally contemplated within the scope of this disclosure. For example, at least some of the shims 50-1, 50-2, 50-3, and 50-4 may include the same thickness (see FIG. 6). In another embodiment, all the shims 50-1, 50-2, 50-3, and 50-4 may include the same thickness (see FIG. 7). Any combination of shim thicknesses may be provided within the selectable shim system 52 and can vary depending on tolerance variations that exist along the first side wall 40-1, for example.

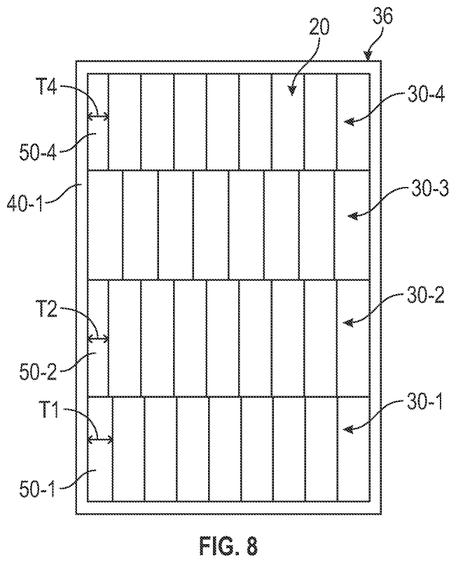

In yet another embodiment, some cell stacks 30 of the cell matrix 32 may not require a shim 50 (see, e.g., the cell stack 30-3 of FIG. 8). Therefore, the selectable shim system 52 could include a fewer number of shims 50 than cell stacks 30 in some implementations.

In yet another embodiment, the shims 50 of the selectable shim system 52 may be provided in multiple thickness increments. The thickness increments may be between 1.5 mm and 6 mm, for example. In an embodiment, the selectable shim system 52 may include 1.5 mm, 3.0 mm, 4.5 mm, and 6 mm shim thicknesses.

Each shim 50 may include a rectangular-shaped body. However, the specific size and shape of each shim 50 of the selectable shim system 52 is not intended to limit this disclosure.

Each shim 50 may be a polymer-based component. In an embodiment, each shim 50 is made of a non-flammable, moldable polymer that includes insulating properties. For example, each shim 50 could be constructed out of nylon, polyurethane, etc. In other implementations, the shims 50 could be metallic-based components.

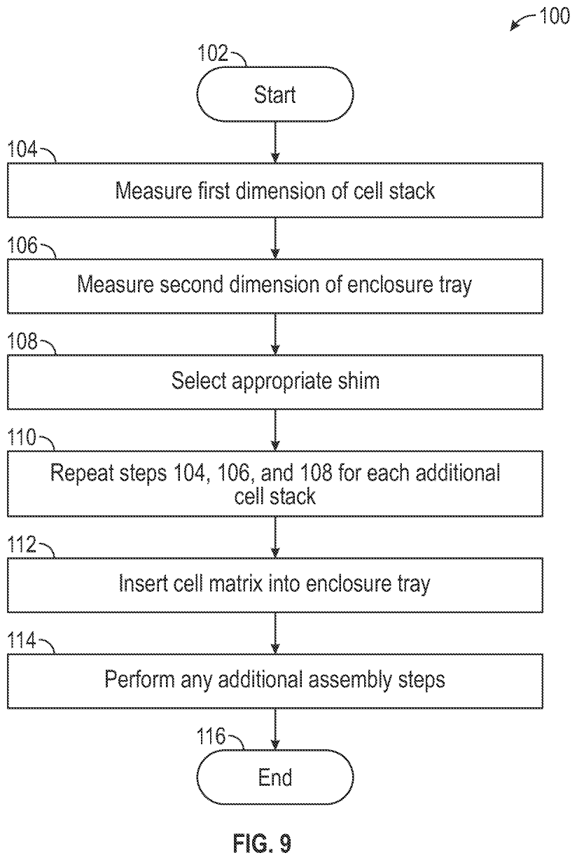

FIG. 9, with continued reference to FIGS. 1-8, schematically illustrates a method 100 for assembling portions of the traction battery pack 18. The method 100 may include a greater or fewer number of steps than recited below, and the exact order of the steps is not intended to limit this disclosure.

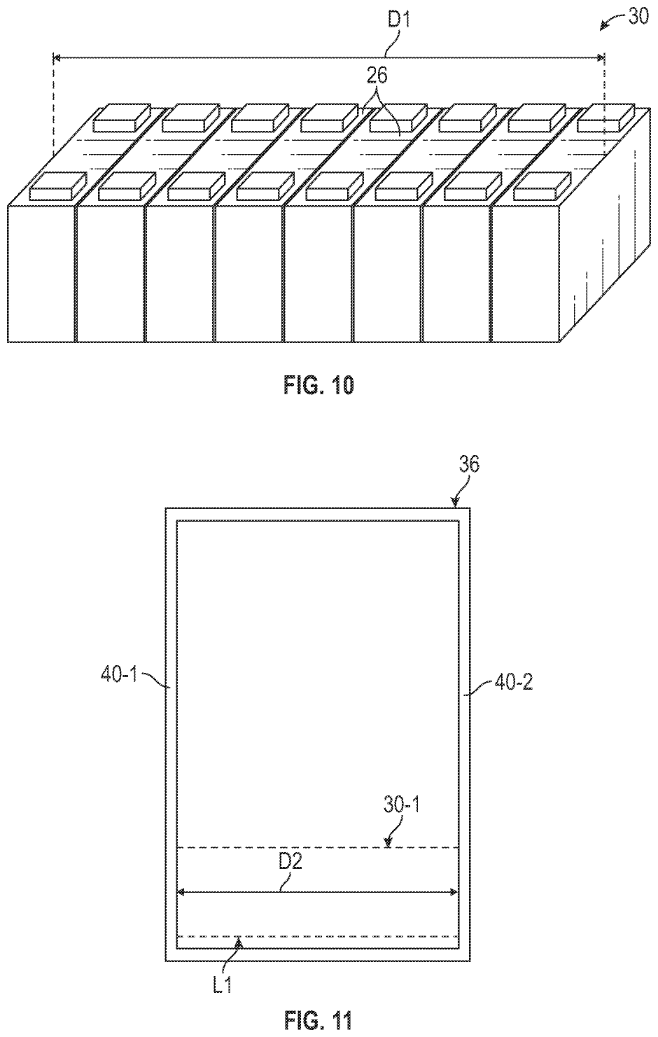

The method may begin at block 102. At block 104, a first dimension D1 associated with a cell stack 30 of the cell-to-pack battery system 20 may be directly measured. In an embodiment, the first dimension D1 is an end-to-end length of the cell stack 30 (see FIG. 10).

Next, at block 106, a second dimension associated with the enclosure tray 36 of the traction battery pack 18 may be directly measured. In an embodiment, the second dimension D2 is a distance between the first side wall 40-1 and an opposing second side wall 40-2 of the enclosure tray 36 at a location L where the cell stack 30 is to be inserted into the cell-compressing opening 42 of the enclosure tray 36 (see FIG. 11).

The dimensions D1 and D2 may be measured using any suitable measuring device. In an embodiment, the dimensions D1 and D2 are directly measured at one or more factory workstations as part of an assembly line manufacturing process for assembling the traction battery pack 18. In another embodiment, the enclosure tray 36 dimensions may be pre-measured and recorded, possibly via a scannable message on the part, and the cell stacks 30 may be compressed to a common length with no reasonable variation, and the shims 50 could be added to the tray 36 strictly based on the tray scannable. In another embodiment, the shims 50 could be pre-attached to the tray 36 such that all trays 36 entering the pack assembly station are of a similar dimension, and all cell stacks 30 are compressed to a similar dimension, and no measurements or adjustments are required at the point of cell matrix/cell stack insertion into the tray 36.

Based on a difference between the second dimension D2 and the first dimension D1, a shim 50 of the selectable shim system 52 may be selected at block 108. The appropriate shim 50 is selected that is capable of augmenting a compressive preload to maintain compression across the battery cells 26 of the cell stack 30 once it is inserted into the cell-compressing opening 42. Selecting the shim 50 at block 108 may include not selecting a shim at all where circumstances so dictate.

Next, at block 110, the process described in blocks 104 to 108 may be repeated for each additional cell stack 30 of the cell matrix 32. The cell matrix 32 (in compressed state with forces Fc and Fx applied) may then be inserted into the cell-compressing opening 42 of the enclosure tray 36 at block 112. The selected shims 50 may be inserted into the enclosure tray 36 before, after, or simultaneous with the insertion of the cell matrix 32. The method 100 may then proceed to block 114 by performing any additional steps necessary for assembling the traction battery pack 18 before ending at block 116.

The exemplary selectable shim systems of this disclosure are configured to provide a compressive preload to the battery cells of a cell matrix of a cell-to-pack battery system. The selectable shim systems therefore provide solutions to various assembly complexities that can arise as a result of eliminating much of the array support structures associated with conventional traction battery packs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including an enclosure tray;
a cell-to-pack battery system housed within the enclosure assembly and including a first cell stack; and
a first shim positioned between a first side wall of the enclosure tray and the first cell stack.

2. The traction battery pack as recited in claim 1, wherein the first cell stack establishes a cell row of a cell matrix of the cell-to-pack battery system.

3. The traction battery pack as recited in claim 2, wherein the enclosure tray provides a cell-compressing opening for compressing the cell matrix.

4. The traction battery pack as recited in claim 1, wherein the first shim is part of a selectable shim system that further includes a second shim positioned between the first side wall and a second cell stack of the cell-to-pack battery system.

5. The traction battery pack as recited in claim 4, wherein the first shim includes a first thickness that is different from a second thickness of the second shim.

6. The traction battery pack as recited in claim 4, wherein the first shim includes a first thickness that is the same as a second thickness of the second shim.

7. The traction battery pack as recited in claim 5, wherein the selectable shim system further includes a third shim positioned between the first side wall and a third cell stack of the cell-to-pack battery system.

8. The traction battery pack as recited in claim 7, wherein the third shim includes a third thickness that is different from the first thickness and the second thickness.

9. The traction battery pack as recited in claim 8, wherein the selectable shim system further includes a fourth shim positioned between the first side wall and a fourth cell stack of the cell-to-pack battery system.

10. The traction battery pack as recited in claim 9, wherein the fourth shim includes a fourth thickness that is different from the first thickness, the second thickness, and the third thickness.

11. The traction battery pack as recited in claim 9, wherein the fourth shim includes a fourth thickness that is the same as the first thickness, the second thickness, or the third thickness.

12. The traction battery pack as recited in claim 1, wherein the first shim includes a plate-like body and is comprised of a non-flammable, moldable polymer that includes insulating properties.

13. The traction battery pack as recited in claim 1, wherein the first shim is arranged to apply a preload to a plurality of battery cells of the first cell stack.

14. The traction battery pack as recited in claim 1, wherein the cell-to-pack battery system includes a second cell stack, and further wherein no shim is positioned between the first side wall and the second cell stack.

15. A method, comprising:
measuring a first dimension associated with a cell stack of a cell-to-pack battery system for a traction battery pack;
measuring a second dimension associated with an enclosure tray of the traction battery pack; and
selecting a shim based on the first dimension and the second dimension.

16. The method as recited in claim 15, wherein measuring the first dimension includes measuring an end-to-end length of the cell stack.

17. The method as recited in claim 15, wherein measuring the second dimension includes measuring a distance between a first side wall and an opposing second side wall of the enclosure tray at a location where the cell stack is to be inserted into the enclosure tray.

18. The method as recited in claim 15, wherein selecting the shim includes selecting the shim based on a difference between the second dimension and the first dimension.

19. The method as recited in claim 15, comprising repeating the measuring and the selecting steps for each additional cell stack of the cell-to-pack battery system, and further comprising inserting the cell stack together with the additional cell stacks into a cell-compressing opening of the enclosure tray.

20. A traction battery pack, comprising:
an enclosure tray;
a first cell stack received within the enclosure tray; and
a first shim positioned between a first side wall of the enclosure tray and the first cell stack.
